(19) United States
(12) Patent Application Publication
(10) Pub. No.: US 2024/0258698 A1
(43) Pub. Date: Aug. 1, 2024

(54) METAL PLATE ANTENNA AND ANTENNA DEVICE

(71) Applicant: KABUSHIKI KAISHA TOKAI RIKA DENKI SEISAKUSHO, Aichi (JP)

(72) Inventors: Koji INAFUNE, Aichi (JP); Kenichi KOGA, Aichi (JP); Tatsuya KOIKE, Aichi (JP); Satoshi MORI, Aichi (JP)

(73) Assignee: KABUSHIKI KAISHA TOKAI RIKA DENKI SEISAKUSHO, Aichi (JP)

(21) Appl. No.: 18/396,054

(22) Filed: Dec. 26, 2023

(30) Foreign Application Priority Data
Jan. 30, 2023 (JP) 2023-011972

(51) Int. Cl. H01Q 9/04

(52) U.S. Cl. CPC H01Q 9/0414; H01Q 9/0421

(57) ABSTRACT

There is provided a metal plate antenna arranged on a substrate, the metal plate antenna comprising: a parallel part arranged in substantially parallel to the substrate; a power feeding point contact part extended from the parallel part substantially perpendicularly to the parallel part, and provided in contact with a power feeding point arranged on the substrate; and a GND contact part formed separately from the power feeding point contact part, extended from the parallel part substantially perpendicularly to the parallel part, and provided in contact with a GND arranged on the substrate, wherein a contact area of the power feeding point contact part and the power feeding point is narrower than a contact area of the GND contact part and the GND.

### CROSS REFERENCE TO RELATED APPLICATION(S)

This application is based upon and claims benefit of priority from Japanese Patent Application No. 2023-011972, filed on Jan. 30, 2023, the entire contents of which are incorporated herein by reference.

### BACKGROUND

The present invention relates to a metal plate antenna and an antenna device.

In recent years, various types of antennas have been developed. The above antennas include, for example, an inverted F antenna as disclosed in JP 2016-39470.

### SUMMARY

However, an antenna such as the inverted F antenna has a problem of impedance matching. Furthermore, a devise for stably arranging an antenna such as an inverted F antenna on a substrate is demanded.

The present invention has been made in light of the above problem, and an object of the present invention is to provide a metal plate antenna that achieves both of impedance matching and stable arrangement of the metal plate antenna on a substrate.

To solve the above described problem, according to an aspect of the present invention, there is provided a metal plate antenna arranged on a substrate, the metal plate antenna comprising: a parallel part arranged in substantially parallel to the substrate: a power feeding point contact part extended from the parallel part substantially perpendicularly to the parallel part, and provided in contact with a power feeding point arranged on the substrate: and a GND contact part formed separately from the power feeding point contact part, extended from the parallel part substantially perpendicularly to the parallel part, and provided in contact with a GND arranged on the substrate, wherein a contact area of the power feeding point contact part and the power feeding point is narrower than a contact area of the GND contact part and the GND.

To solve the above described problem, according to another aspect of the present invention, there is provided an antenna device comprising: a substrate; and a metal plate antenna arranged on a substrate, wherein the metal plate antenna includes: a parallel part arranged in substantially parallel to the substrate: a power feeding point contact part extended from the parallel part substantially perpendicularly to the parallel part, and provided in contact with a power feeding point arranged on the substrate: and a GND contact part formed separately from the power feeding point contact part, extended from the parallel part substantially perpendicularly to the parallel part, and provided in contact with a GND arranged on the substrate, and a contact area of the power feeding point contact part and the power feeding point is narrower than a contact area of the GND contact part and the GND.

As described above, the present invention can provide a metal plate antenna that achieves both of impedance matching and stable arrangement of the metal plate antenna on a substrate.

### BRIEF DESCRIPTION OF THE DRAWINGS

FIG. 1 is a diagram illustrating a shape example of an inverted F antenna 110 that is an example of a metal plate antenna according to an embodiment of the present invention.

FIG. 2 is a diagram illustrating a shape example of the inverted F antenna 110 that is an example of the metal plate antenna according to the embodiment.

FIG. 3 is a diagram illustrating a shape example of the inverted F antenna 110 that is an example of the metal plate antenna according to the embodiment.

FIG. 4 is a diagram illustrating a shape example of the inverted F antenna 110 that is an example of the metal plate antenna according to the embodiment.

FIG. 5 is a diagram illustrating a shape example of a branched power feeding transmission line antenna 120 that is an example of the metal plate antenna according to the embodiment.

FIG. 6 is a diagram illustrating a shape example of the branched power feeding transmission line antenna 120 that is an example of the metal plate antenna according to the embodiment.

FIG. 7 is a diagram illustrating a shape example of the branched power feeding transmission line antenna 120 that is an example of the metal plate antenna according to the embodiment.

FIG. 8 is a diagram illustrating a shape example of the branched power feeding transmission line antenna 120 that is an example of the metal plate antenna according to the embodiment.

FIG. 9 is a diagram illustrating a shape example of the branched power feeding transmission line antenna 120 that is an example of the metal plate antenna according to the embodiment.

FIG. 10 is a diagram for describing opening parts 210I formed in the vicinity just above a contact portion of a GND contact part 136I and a substrate 150 according to the embodiment.

FIG. 11 is a diagram for describing slits 220I according to the embodiment.

FIG. 12 is a diagram for describing the slits 220I according to the embodiment.

FIG. 13 is a diagram for describing the opening parts 210I that are structures for causing a current to detour according to the embodiment.

FIG. 14 is a diagram illustrating a variation example of the shape of a power feeding point contact part 134I of a branched power feeding transmission line antenna 120I according to the embodiment.

FIG. 15 is a diagram illustrating a formation example of stabs 240I according to the embodiment.

FIG. 16 is a diagram illustrating an example of a mold structure according to the embodiment.

FIG. 17 is a diagram for describing a shape example of support parts 260I according to the embodiment.

FIG. 18 is a diagram for describing the branched power feeding transmission line antenna 120I formed by a plurality of metal plates according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

Furthermore, the same types of a plurality of existing components will be distinguished and described by assigning alphabets to ends of reference numerals in this description and the drawings in some cases. On the other hand, in a case where the same types of the plurality of existing components do not need to be distinguished, the above alphabets will be omitted, and common description will be made on all of the same types of the plurality of existing components in some cases.

### 1. Embodiment

### <<1.1. Shape Examples of Metal Plate Antenna>>

First, the shape example of the metal plate antenna included in an antenna device 10 according to the embodiment of the present invention will be described.

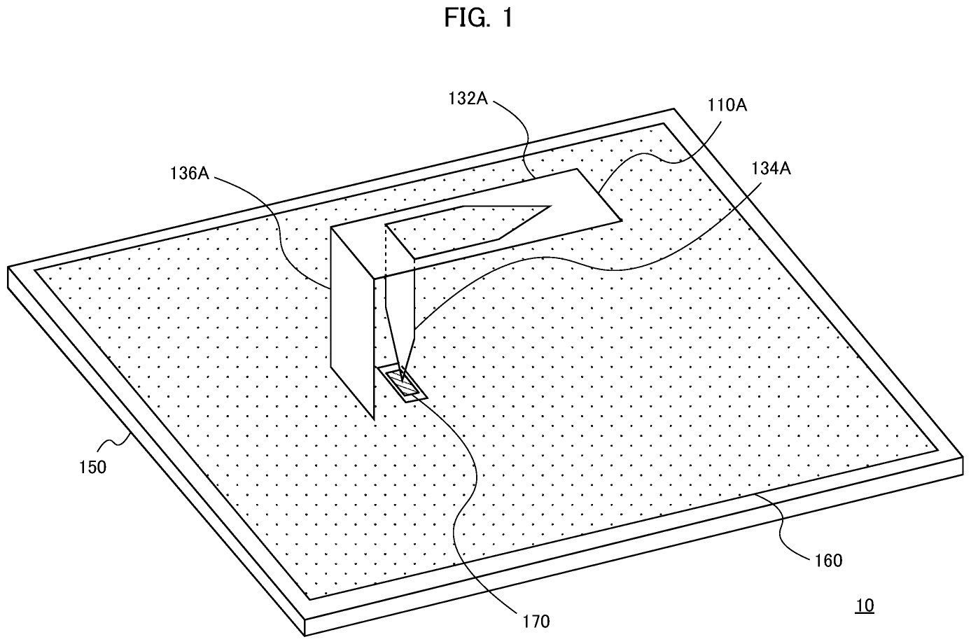

The metal plate antenna according to the present embodiment may be, for example, an inverted F antenna 110 as illustrated in FIGS. 1 to 4.

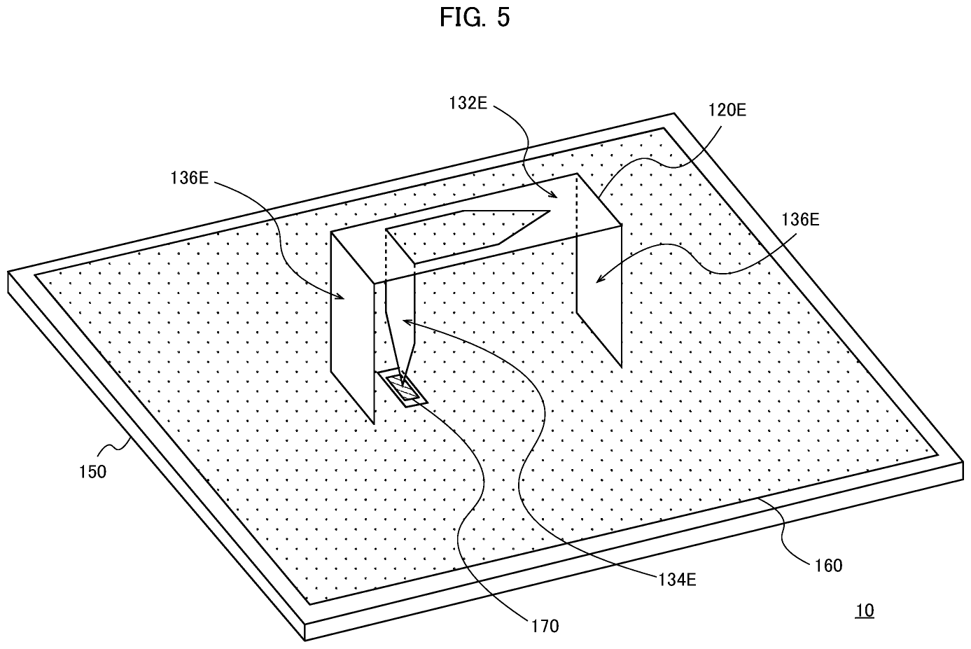

On the other hand, the metal plate antenna according to the present embodiment may be, for example, a branched power feeding transmission line antenna 120 as illustrated in FIGS. 5 to 9.

The metal plate antenna according to the present embodiment has been conceived focusing on achieving both of impedance matching and stable arrangement of the metal plate antenna on a substrate 150, and has a characteristic shape described later.

The metal plate antenna according to the present embodiment includes a parallel part 132, a power feeding point contact part 134, and a GND contact part 136.

The parallel part 132 according to the present embodiment may be a flat plate component that is not in contact with the substrate 150. The parallel part 132 according to the present embodiment may be arranged, for example, in substantially parallel to the substrate 150.

The power feeding point contact part 134 according to the present embodiment is extended from the parallel part 132 substantially perpendicularly to the parallel part 132, and has the lower end that is in contact with a power feeding point 170 arranged on the substrate 150.

The GND contact part 136 according to the present embodiment is formed separately from the power feeding point contact part 134, is extended from the parallel part 132 substantially perpendicularly to the parallel part 132, and has the lower end that is in contact with a GND 160 arranged on the substrate 150.

Furthermore, one of features of the metal plate antenna according to the present embodiment is that a contact area of the power feeding point contact part 134 and the power feeding point 170 is narrower than a contact area of the GND contact part 136 and the GND 160.

The above feature provides an effect of facilitating impedance matching while stably arranging the metal plate antenna on the substrate 150.

Furthermore, the metal plate antenna according to the present embodiment transmits and receives wireless signals that conform to, for example, specific communication standards such as Ultra-Wide Band (UWB) wireless communication.

Hence, an antenna length of the metal plate antenna according to the present embodiment defined by the lengths of the parallel part 132 and the GND contact part 136 may be determined based on the wavelength of the wireless signal that conforms to the specific communication standards.

Hereinafter, the shape examples of the inverted F antenna 110 that are examples of the metal plate antenna according to the present embodiment will be described in detail with reference to each of FIGS. 1 to 4 in order.

In an inverted F antenna 110A illustrated in FIG. 1, a power feeding point contact part 134A is formed by cutting out part of an area of a parallel part 132A.

The power feeding point contact part 134A extended from the parallel part 132A has the lower end that is in contact with the power feeding point 170 (indicated by a diagonal line pattern) arranged on the substrate 150.

Note that the shape of the power feeding point 170 illustrated in FIG. 1 or the like is merely schematically illustrated, and the shape of the power feeding point 170 according to the present embodiment is not limited.

Furthermore, the inverted F antenna 110A illustrated in FIG. 1 has the shape formed by extending a GND contact part 136A from the one end of the parallel part 132A.

The GND contact part 136A has the lower end that is in contact with the GND 160 (indicated by a dot pattern) arranged on the substrate 150.

Thus, the inverted F antenna 110A according to the present embodiment is supported by two support points (a contact portion of the power feeding point contact part 134A and the power feeding point 170, and a contact portion of the GND contact portion 136A and the GND 160) on the substrate 150.

The above two support points may be subjected to a fixing process using, for example, a conductive adhesive such as a solder.

Consequently, it is possible to stably arrange the inverted F antenna 110A on the substrate 150.

Furthermore, as illustrated in FIG. 1, one of the features of the inverted F antenna 110A is that a contact area of the power feeding point contact part 134A and the power feeding point 170 is narrower than a contact area of the GND contact part 136A and the GND 160.

According to the above feature, it is possible to easily perform impedance matching, and efficiently achieve desired antenna characteristics.

Furthermore, the inverted F antenna 110A according to the present embodiment can be manufactured at low cost by press-machining one metal plate.

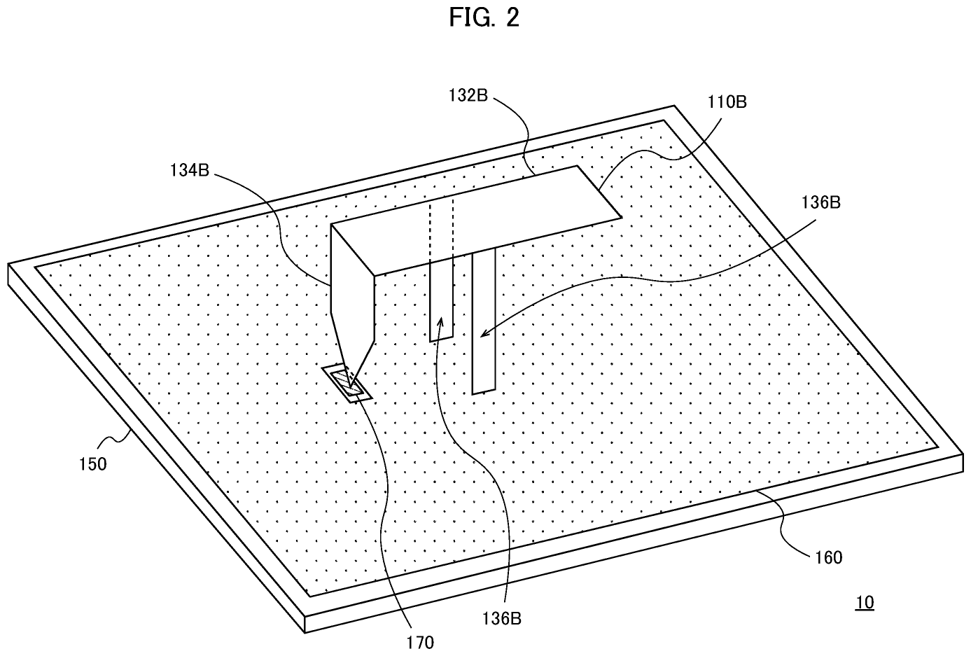

Next, the shape of an inverted F antenna 110B according to the present embodiment will be described with reference FIG. 2.

The inverted F antenna 110B illustrated in FIG. 2 has the shape formed by extending a power feeding point contact part 134B from the one end of a parallel part 132B, and extending two GND contact parts 136B from between the one end and the other end of the parallel part 132B.

The power feeding point contact part 134B extended from the parallel part 132B has the lower end that is in contact with the power feeding point 170 arranged on the substrate 150.

Furthermore, the two GND contact parts 136B extended from the parallel part 132B have the lower ends that are in contact with the GND 160 arranged on the substrate 150.

Thus, the inverted F antenna 110B according to the present embodiment is supported by three support points on the substrate 150.

Consequently, it is possible to stably arrange the inverted F antenna 110B on the substrate 150.

Furthermore, as illustrated in FIG. 2, one of the features of the inverted F antenna 110B is that a contact area of the power feeding point contact part 134B and the power feeding point 170 is narrower than a contact area of the GND contact part 136B and the GND 160.

According to the above feature, it is possible to easily perform impedance matching, and efficiently achieve desired antenna characteristics.

Furthermore, the inverted F antenna 110B according to the present embodiment can be manufactured at low cost by press-machining one metal plate.

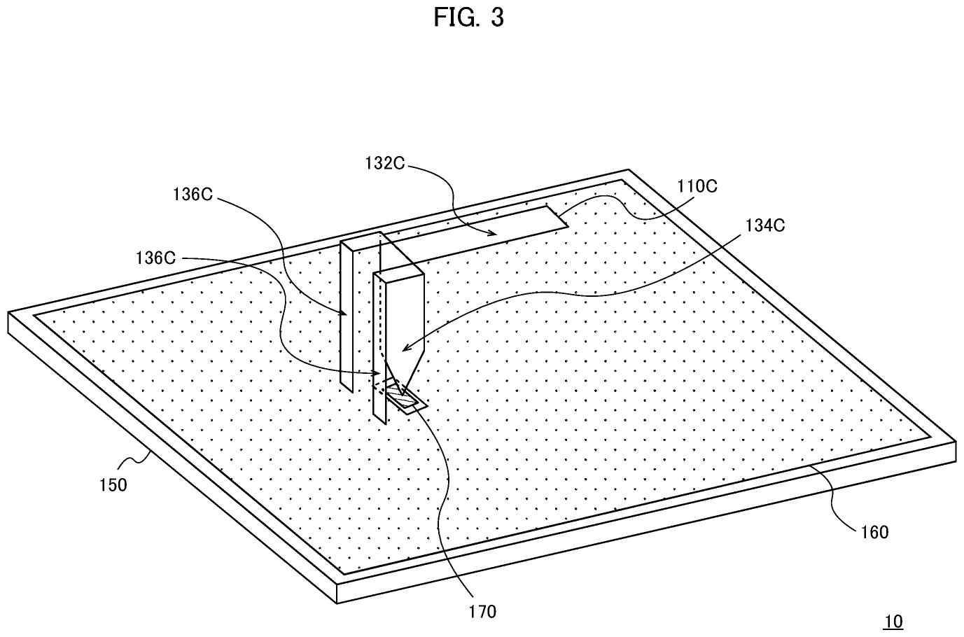

Next, the shape of an inverted F antenna 110C according to the present embodiment will be described with reference FIG. 3.

The inverted F antenna 110C illustrated in FIG. 3 has the shape formed by extending the power feeding point contact part 134B from the one end of a parallel part 132C, and extending two GND contact parts 136C from the same one end.

The power feeding point contact part 134C extended from the parallel part 132C has the lower end that is in contact with the power feeding point 170 arranged on the substrate 150.

Furthermore, the two GND contact parts 136C extended from the parallel part 132C have the lower ends that are in contact with the GND 160 arranged on the substrate 150.

Thus, the inverted F antenna 110C according to the present embodiment is supported by three support points on the substrate 150.

Consequently, it is possible to stably arrange the inverted F antenna 110C on the substrate 150.

Furthermore, as illustrated in FIG. 3, one of the features of the inverted F antenna 110C is that a contact area of the power feeding point contact part 134C and the power feeding point 170 is narrower than a contact area of the GND contact part 136C and the GND 160.

According to the above feature, it is possible to easily perform impedance matching, and efficiently achieve desired antenna characteristics.

Furthermore, the inverted F antenna 110C according to the present embodiment can be manufactured at low cost by press-machining one metal plate.

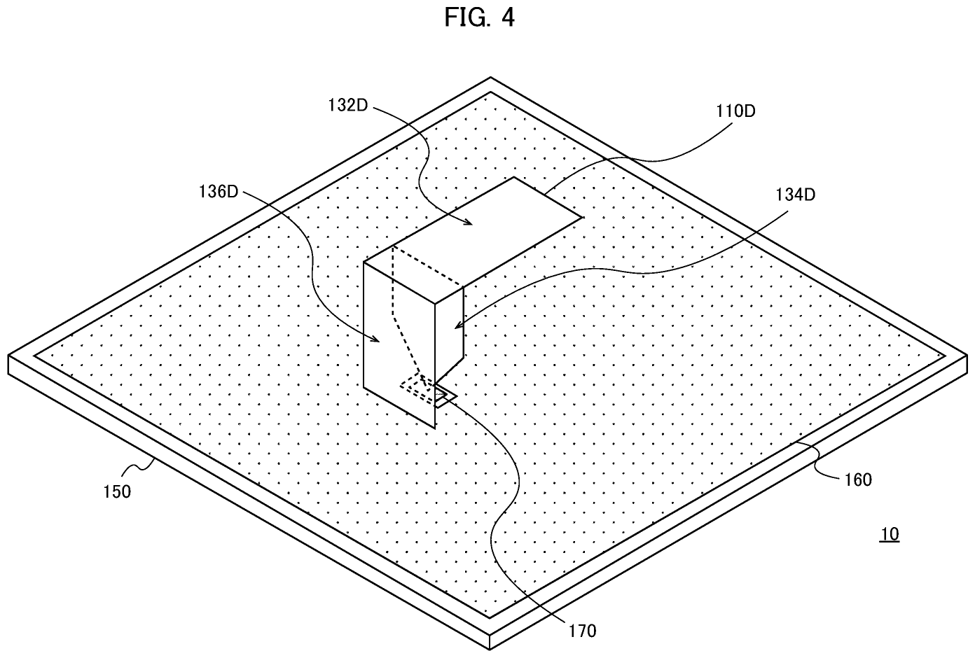

Next, the shape of an inverted F antenna 110D according to the present embodiment will be described with reference FIG. 4.

The inverted F antenna 110D illustrated in FIG. 4 has the shape formed by extending a GND contact part 136D from the one end of a parallel part 132D, and extending the power feeding point contact part 134D from between the one end and the other end of the parallel part 132D.

The power feeding point contact part 134D extended from the parallel part 132D has the lower end that is in contact with the power feeding point 170 arranged on the substrate 150.

Furthermore, the GND contact part 136D extended from the parallel part 132D has the lower end that is in contact with the GND 160 arranged on the substrate 150.

Thus, the inverted F antenna 110D according to the present embodiment is supported by two support points on the substrate 150.

Consequently, it is possible to stably arrange the inverted F antenna 110D on the substrate 150.

Furthermore, as illustrated in FIG. 4, one of the features of the inverted F antenna 110D is that a contact area of the power feeding point contact part 134D and the power feeding point 170 is narrower than a contact area of the GND contact part 136D and the GND 160.

According to the above feature, it is possible to easily perform impedance matching, and efficiently achieve desired antenna characteristics.

The shape examples of the inverted F antenna 110 according to the present embodiment have been described above with reference to FIGS. 1 to 4. In this regard, the shapes of the inverted F antenna 110 described with reference to FIGS. 1 to 4 are merely examples, and the shapes of the inverted F antenna 110 according to the present embodiment are not limited to these examples. The shape of the inverted F antenna 110 according to the present embodiment can be flexibly modified.

Next, shape examples of the branched power feeding transmission line antenna 120 that are examples of the metal plate antenna according to the present embodiment will be described in detail with reference to each of FIGS. 5 to 9 in order.

In a branched power feeding transmission line antenna 120E illustrated in FIG. 5, a power feeding point contact part 134E is formed by cutting out part of an area of a parallel part 132E.

The power feeding point contact part 134E extended from the parallel part 132E has the lower end that is in contact with the power feeding point 170 arranged on the substrate 150.

Furthermore, the branched power feeding transmission line antenna 120E illustrated in FIG. 5 includes two GND contact parts 136E that extend from each of the one end and the other end of the parallel part 132E.

The two GND contact parts 136E have the lower ends that are in contact with the GND 160 arranged on the substrate 150.

Thus, the branched power feeding transmission line antenna 120E according to the present embodiment is supported by three support points on the substrate 150.

Consequently, it is possible to stably arrange the branched power feeding transmission line antenna 120E on the substrate 150.

Furthermore, as illustrated in FIG. 5, one of the features of the branched power feeding transmission line antenna 120E is that a contact area of the power feeding point contact part 134E and the power feeding point 170 is narrower than a contact area of the GND contact part 136E and the GND 160.

According to the above feature, it is possible to easily perform impedance matching, and efficiently achieve desired antenna characteristics.

Furthermore, the branched power feeding transmission line antenna 120E according to the present embodiment can be manufactured at low cost by press-machining one metal plate.

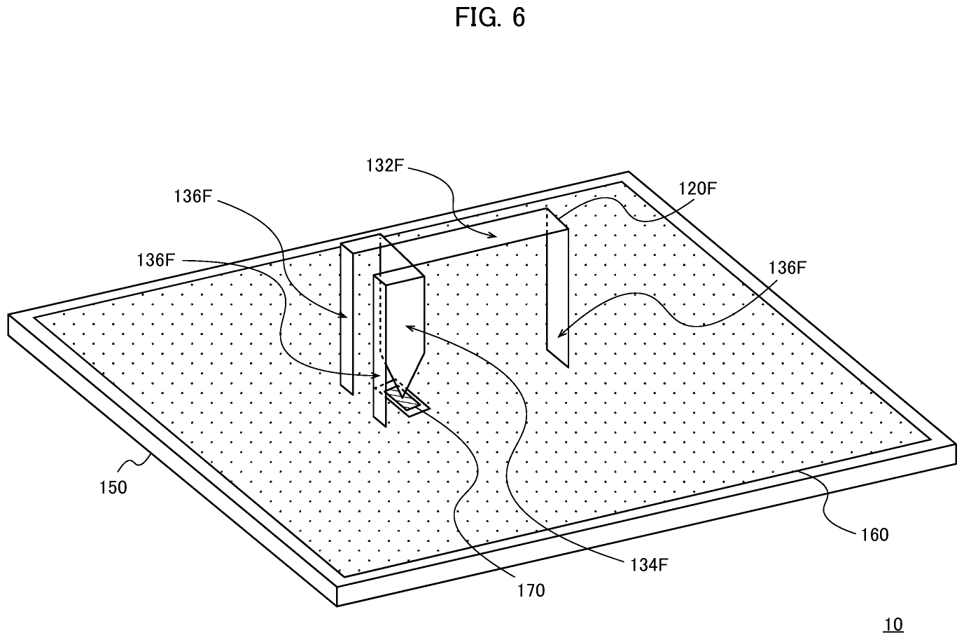

Next, the shape of a branched power feeding transmission line antenna 120F according to the present embodiment will be described with reference FIG. 6.

The branched power feeding transmission line antenna 120F illustrated in FIG. 6 includes a power feeding point contact part 134F that is extended from the one end of a parallel part 132F.

The power feeding point contact part 134F extended from the parallel part 132F has the lower end that is in contact with the power feeding point 170 arranged on the substrate 150.

Furthermore, the branched power feeding transmission line antenna 120F illustrated in FIG. 6 includes two GND contact parts 136F that are extended from the above one end of the parallel part 132F, and the one GND contact part 136F that is extended from the other end of the parallel part 132F.

The above three GND contact parts 136F have the lower ends that are in contact with the GND 160 arranged on the substrate 150.

Thus, the branched power feeding transmission line antenna 120F according to the present embodiment is supported by four support points on the substrate 150.

Consequently, it is possible to stably arrange the branched power feeding transmission line antenna 120F on the substrate 150.

Furthermore, as illustrated in FIG. 6, one of the features of the branched power feeding transmission line antenna 120F is that a contact area of the power feeding point contact part 134F and the power feeding point 170 is narrower than a contact area of the GND contact part 136F and the GND 160.

According to the above feature, it is possible to easily perform impedance matching, and efficiently achieve desired antenna characteristics.

Furthermore, the branched power feeding transmission line antenna 120F according to the present embodiment can be manufactured at low cost by press-machining one metal plate.

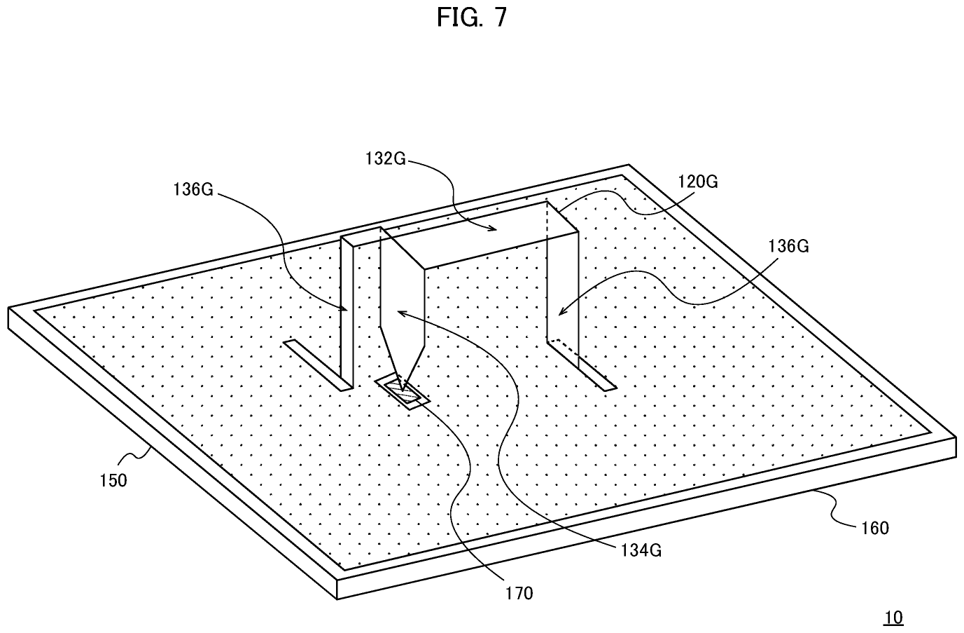

Next, the shape of a branched power feeding transmission line antenna 120G according to the present embodiment will be described with reference FIG. 7.

The branched power feeding transmission line antenna 120G illustrated in FIG. 7 includes a power feeding point contact part 134G that is extended from the one end of a parallel part 132G.

The power feeding point contact part 134G extended from the parallel part 132G has the lower end that is in contact with the power feeding point 170 arranged on the substrate 150.

Furthermore, the branched power feeding transmission line antenna 120G illustrated in FIG. 7 includes a GND contact part 136G that is extended from the above one end of the parallel part 132G, and the GND contact part 136G that is extended from the other end of the parallel part 132G.

The above two GND contact parts 136G have the lower ends that are in contact with the GND 160 arranged on the substrate 150.

Thus, the branched power feeding transmission line antenna 120G according to the present embodiment is supported by three support points on the substrate 150.

Consequently, it is possible to stably arrange the branched power feeding transmission line antenna 120G on the substrate 150.

Furthermore, as illustrated in FIG. 7, a contact portion of the lower end of the GND contact part 136G and the GND 160 may have a bending structure. Consequently, it is possible to obtain an effect that a contact area of the GND contact part 136G and the substrate 150 is expanded, it is easy to form a fillet at a time of fixing using a conductive adhesive such as a solder, and, moreover, it is easy to check the formed fillet.

Note that the above bending structure is applicable to each of the GND contact parts 136 illustrated in FIGS. 1 to 9 and each of the power feeding point contact parts 134.

Furthermore, as illustrated in FIG. 7, one of the features of the branched power feeding transmission line antenna 120G is that a contact area of the power feeding point contact part 134G and the power feeding point 170 is narrower than a contact area of the GND contact part 136G and the GND 160.

According to the above feature, it is possible to easily perform impedance matching, and efficiently achieve desired antenna characteristics.

Furthermore, the branched power feeding transmission line antenna 120G according to the present embodiment can be manufactured at low cost by press-machining one metal plate.

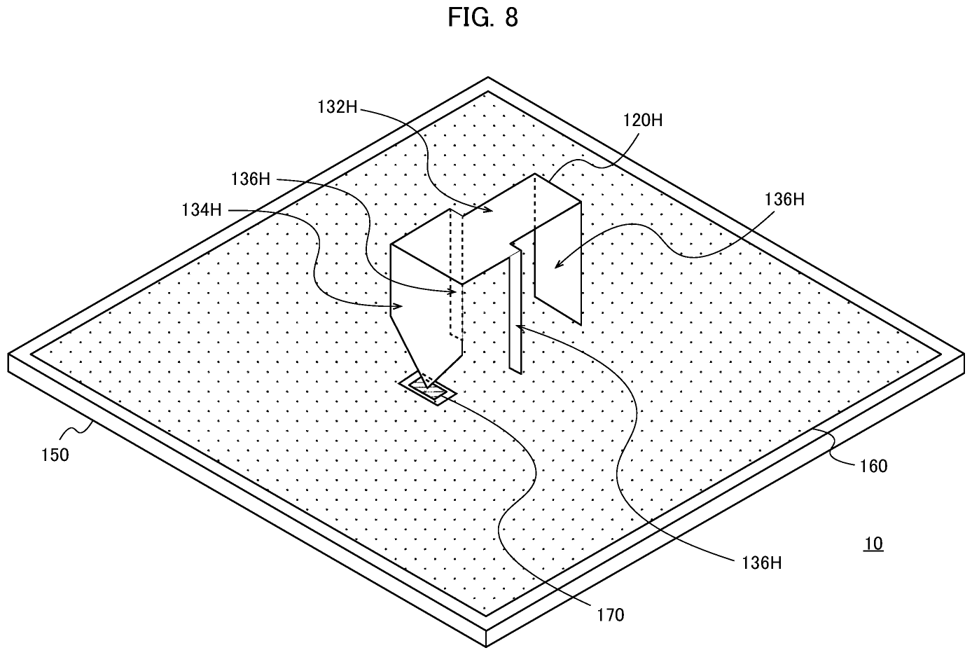

Next, the shape of a branched power feeding transmission line antenna 120H according to the present embodiment will be described with reference FIG. 8.

The branched power feeding transmission line antenna 120H illustrated in FIG. 8 includes a power feeding point contact part 134H that is extended from the one end of a parallel part 132H.

The power feeding point contact part 134H extended from the parallel part 132H has the lower end that is in contact with the power feeding point 170 arranged on the substrate 150.

Furthermore, the branched power feeding transmission line antenna 120H illustrated in FIG. 8 includes one GND contact part 136H that is extended from the other end of the parallel part 132H, and the two GND contact parts 136H that are extended from between the one end and the other end of the parallel part 132H.

The above three GND contact parts 136H have the lower ends that are in contact with the GND 160 arranged on the substrate 150.

Thus, the branched power feeding transmission line antenna 120H according to the present embodiment is supported by four support points on the substrate 150.

Consequently, it is possible to stably arrange the branched power feeding transmission line antenna 120G on the substrate 150.

Furthermore, as illustrated in FIG. 8, one of the features of the branched power feeding transmission line antenna 120H is that a contact area of the power feeding point contact part 134H and the power feeding point 170 is narrower than a contact area of the GND contact part 136H and the GND 160.

According to the above feature, it is possible to easily perform impedance matching, and efficiently achieve desired antenna characteristics.

Furthermore, the branched power feeding transmission line antenna 120H according to the present embodiment can be manufactured at low cost by press-machining one metal plate.

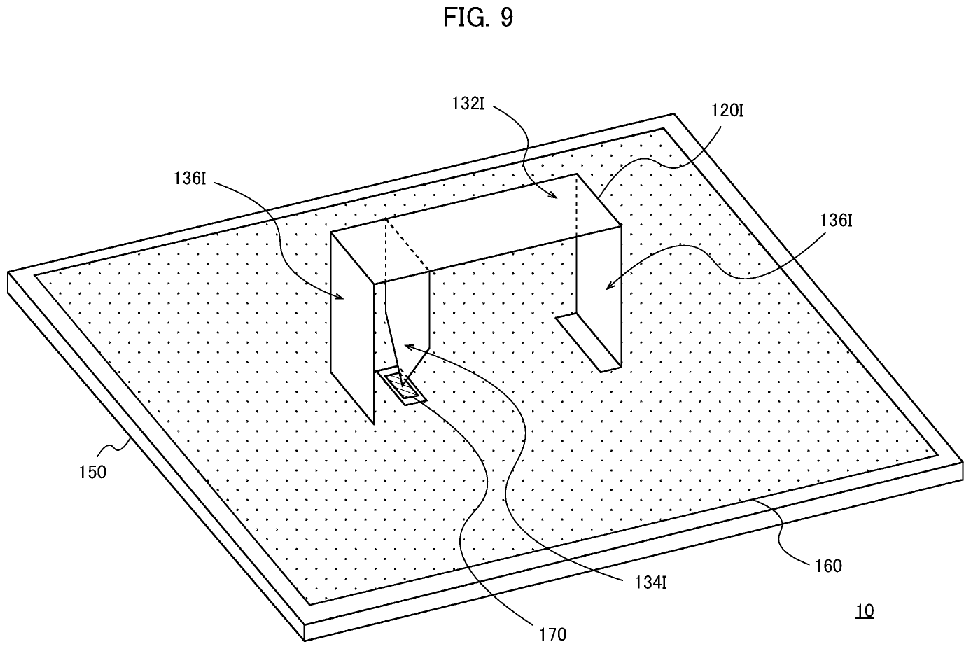

Next, the shape of a branched power feeding transmission line antenna 120I according to the present embodiment will be described with reference FIG. 9.

The branched power feeding transmission line antenna 120I illustrated in FIG. 9 includes a power feeding point contact part 134I that is extended from between the one end and the other end of a parallel part 132I.

The power feeding point contact part 134I extended from the parallel part 132I has the lower end that is in contact with the power feeding point 170 arranged on the substrate 150.

Furthermore, the branched power feeding transmission line antenna 120I illustrated in FIG. 9 includes two GND contact parts 136I that are extended from the one end and the other end of the parallel part 132I.

The above two GND contact parts 136I have the lower ends that are in contact with the GND 160 arranged on the substrate 150.

Thus, the branched power feeding transmission line antenna 120I according to the present embodiment is supported by three support points on the substrate 150.

Consequently, it is possible to stably arrange the branched power feeding transmission line antenna 120I on the substrate 150.

Furthermore, as illustrated in FIG. 9, one of the features of the branched power feeding transmission line antenna 120I is that a contact area of the power feeding point contact part 134I and the power feeding point 170 is narrower than a contact area of the GND contact part 136I and the GND 160.

According to the above feature, it is possible to easily perform impedance matching, and efficiently achieve desired antenna characteristics.

The shape examples of the branched power feeding transmission line antenna 120 according to the present embodiment have been described with reference to FIGS. 5 to 9. In this regard, the shapes of the branched power feeding transmission line antenna 120 described with reference to FIGS. 5 to 9 are merely examples, and the shapes of the branched power feeding transmission line antenna 120 according to the present embodiment are not limited to these examples. The shape of the branched power feeding transmission line antenna 120 according to the present embodiment can be flexibly modified.

### <<1.2. Modified Examples of Metal Plate Antenna>>

The metal plate antenna according to the present embodiment has been basically described above. Next, the modified examples of the metal plate antenna according to the present embodiment will be described.

Note that, although description on the following modified examples will adopt the branched power feeding transmission line antenna 120I as a main example, the inverted F antennas 110A to 110D and the branched power feeding transmission line antennas 120E to 120H can be also modified likewise.

First, a modified example of the GND contact part included in the metal plate antenna will be described.

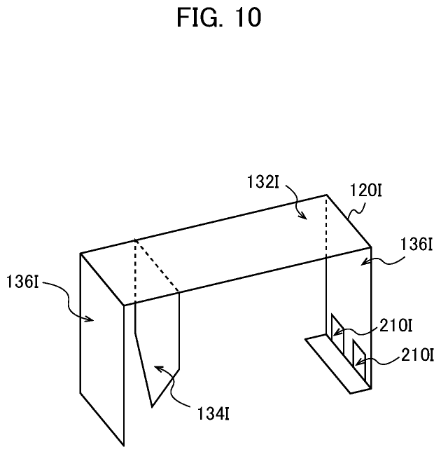

As illustrated in FIG. 10, the branched power feeding transmission line antenna 120I according to the present embodiment may include opening parts 210I in the vicinity just above the contact portions of the GND contact parts 136I and the substrate 150.

The branched power feeding transmission line antenna 120I is formed using a metal material, and therefore has high thermal conductivity. Hence, when fixing is performed using a conductive adhesive such as a solder, heat tends to escape upward.

However, in a case where the opening parts 210I are formed in the vicinity just above the contact portions of the GND contact parts 136I and the substrate 150 as illustrated in FIG. 10, it is possible to effectively prevent heat from escaping upward, and efficiently perform fixing using a conductive adhesive such as a solder.

Next, a modified example where an antenna length is secured will be described.

To secure the antenna length of interest, the branched power feeding transmission line antenna 120I according to the present embodiment may have a structure such as slits 220I for causing a current to detour.

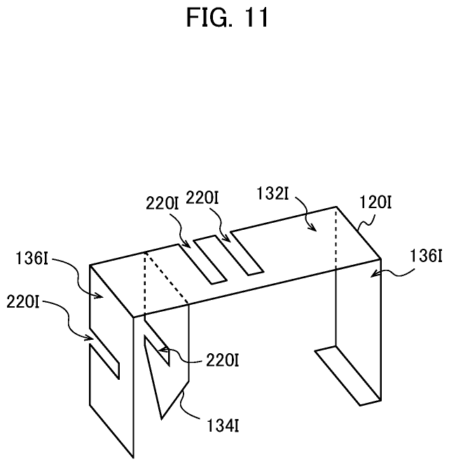

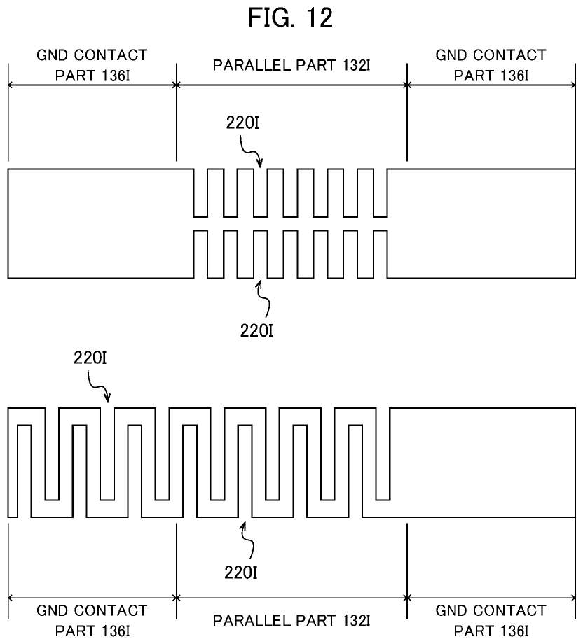

FIGS. 11 and 12 are diagrams for describing slits 220I according to the present embodiment.

As illustrated in FIG. 11, the branched power feeding transmission line antenna 120I according to the present embodiment may include one or a plurality of the slits 220I in the parallel part 132I, the power feeding point contact part 134I, or the GND contact parts 136I.

In a case where the branched power feeding transmission line antenna 120I includes the slits 220I as illustrated in FIG. 11, the current flows detouring through the slits 220I, so that it is possible to secure a longer antenna length defined by the lengths of the parallel part 132I, the power feeding point contact part 134I, and the GND contact parts 136I.

Note that, although FIG. 11 exemplifies the case where the plurality of slits 220I are formed in the same direction, a formation pattern of the slits 220I according to the present embodiment is not limited to this example.

The slits 220I according to the present embodiment may be formed in opposing two directions as illustrated at, for example, the upper part and the lower part in FIG. 12.

Furthermore, structures that are formed in the branched power feeding transmission line antenna 120I and cause a current to detour are not limited to the slits 220I. The structures may be the opening parts 210I.

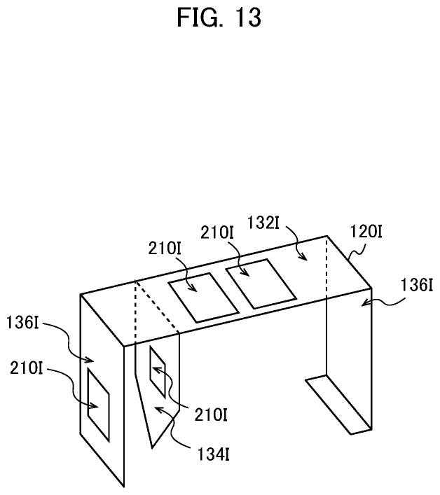

FIG. 13 is a diagram for describing the opening parts 210I as structures for causing a current to detour.

As illustrated in FIG. 13, the branched power feeding transmission line antenna 120I according to the present embodiment may include one or a plurality of the opening parts 210I in the parallel part 132I, the power feeding point contact part 134I, or the GND contact parts 136I.

In a case where the GND contact parts 136I include the opening parts 210I as illustrated in FIG. 13, the current flows detouring through the opening parts 210I, so that it is possible to secure a longer antenna length defined by the lengths of the parallel part 132I, the power feeding point contact part 134I, and the GND contact parts 136I.

The slits 220I and the opening parts 210I that are the structures for causing a current to detour have been described above. Formation patterns of the slits 220I and the opening parts 210I may be designed as appropriate according to an antenna length of interest, the size of the branched power feeding transmission line antenna 120I, and the like.

The modified example where the antenna length is secured has been described above. Next, a modified example on the shape of the power feeding point contact part 134I will be described.

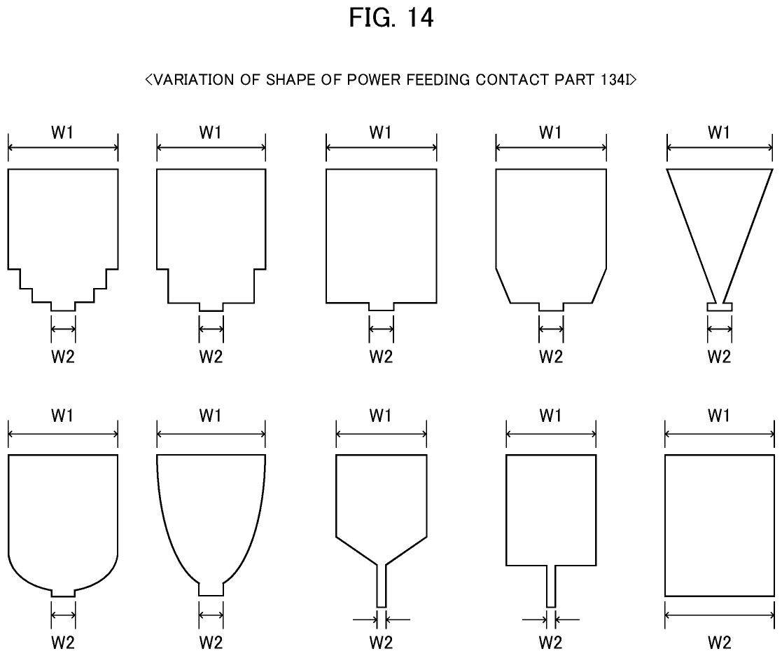

FIG. 14 is a diagram illustrating a variation example of the shape of the power feeding point contact part 134I of the branched power feeding transmission line antenna 120I according to the present embodiment.

The power feeding point contact part 134I of the branched power feeding transmission line antenna 120I according to the present embodiment may be formed such that a width W2 of the lower end that is in contact with the power feeding point 170 is shorter than a width W1 of the upper end.

According to the above shape, it is possible to obtain an effect that it is easy to perform impedance matching.

In this regard, in a case where impedance matching can be performed by other means, the width W2 of the lower end may be approximately the same as the width W1 of the upper end as illustrated at the right end of the lower part in FIG. 14.

Next, a modified example in a case where the branched power feeding transmission line antenna 120I according to the present embodiment includes stabs 240I will be described.

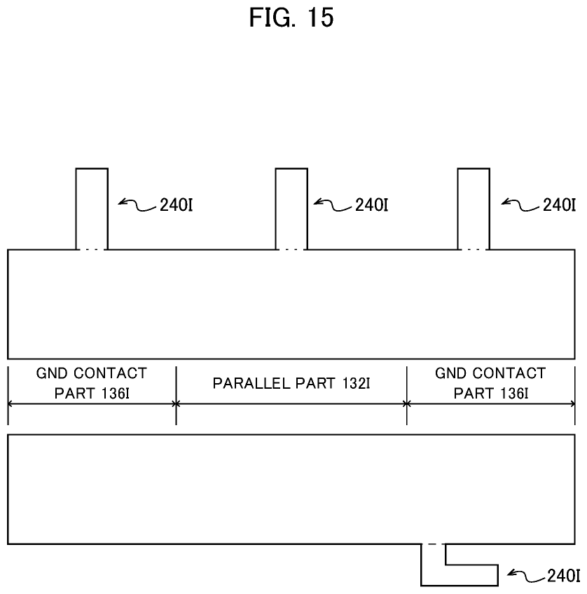

FIG. 15 is a diagram illustrating a formation example of the stabs 240I according to the present embodiment.

As illustrated in FIG. 15, the branched power feeding transmission line antenna 120I according to the present embodiment may include one or a plurality of the stabs 240I in one or more of the parallel part 132I, the power feeding point contact part 134I, or the GND contact parts 136I.

As illustrated at the upper part in FIG. 15, the stabs 240I may be formed by being extended in a direction substantially perpendicularly to a direction that connects the power feeding point contact part 134 and the GND contact parts 136I.

The stabs 240I formed as described above can cause a current to further flow in the direction perpendicular to the direction that connects the power feeding point contact part 134I and the GND contact parts 136I, and consequently can cause the branched power feeding transmission line antenna 120I to function as a circularly polarized antenna.

Alternatively, as illustrated at the lower part in FIG. 15, the stab 240I may be formed by being extended in the direction substantially perpendicularly to the direction that connects the power feeding point contact part 134I and the GND contact part 136I, and then being further extended toward the substrate 150.

Furthermore, the stab 240I may be bent at, for example, a portion indicated by a two-dot-dash line in FIG. 15.

The stabs 240I according to the present embodiment can efficiently adjust a polarized wave and the antenna length.

Next, a mold structure according to the present embodiment will be described.

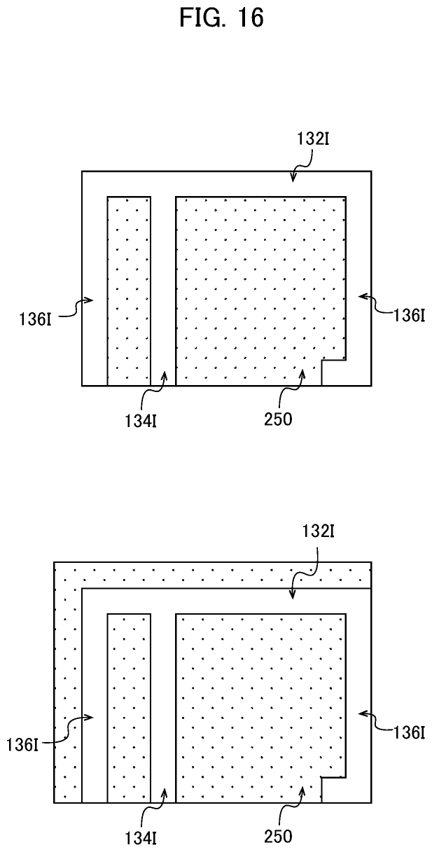

FIG. 16 is a diagram illustrating an example of the mold structure according to the present embodiment.

As illustrated at the upper part in FIG. 16, an insulation material 250 may be filled in a space surrounded by at least two of the parallel part 132I, the power feeding point contact part 134I, and the GND contact parts 136I according to the present embodiment.

Alternatively, as illustrated at the lower part in FIG. 16, in the branched power feeding transmission line antenna 120I according to the present embodiment, in addition to the above space, the outer side of at least one of the parallel part 132I, the power feeding point contact part 134I, and the GND contact parts 136I may be covered with the insulation material 250.

This mold structure that uses the insulation material 250 can effectively prevent change of the shape of the branched power feeding transmission line antenna 120I.

Next, a modified example in a case where the branched power feeding transmission line antenna 120I according to the present embodiment includes support parts 260I will be described.

The support parts 260I according to the present embodiment are components that support the branched power feeding transmission line antenna 120I to stand by itself on the substrate 150.

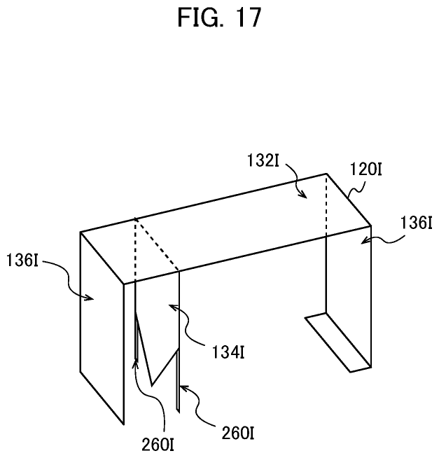

FIG. 17 is a diagram for describing a shape example of the support parts 260I according to the present embodiment.

As illustrated in FIG. 17, the power feeding point contact part 134I of the branched power feeding transmission line antenna 120I according to the present embodiment may include one or a plurality of the support parts 260I.

The support parts 260I according to the present embodiment enable the branched power feeding transmission line antenna 120I to more stably stand by itself on the substrate 150.

Next, a modified example of the metal plate according to the present embodiment will be described.

The case where the metal plate antenna according to the present embodiment is formed by one metal plate has been mainly described above.

On the other hand, the metal plate antenna according to the present embodiment may be formed by a plurality of metal plates.

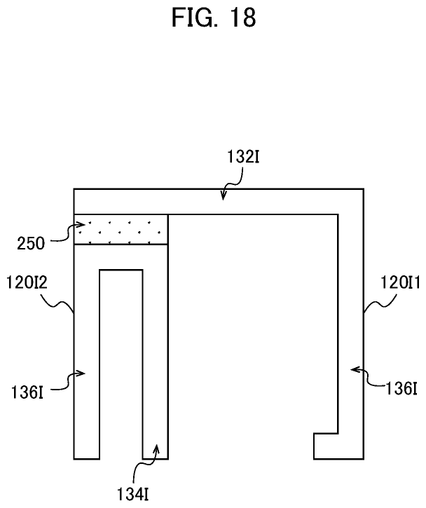

FIG. 18 is a diagram for describing the branched power feeding transmission line antenna 120I formed by a plurality of metal plates according to the present embodiment.

As illustrated in FIG. 18, the branched power feeding transmission line antenna 120I according to the present embodiment may be formed by a metal plate 120I1 and a metal plate 120I2.

While a region between the metal plate 120I1 and the metal plate 120I2 is not directly conducted, the region operates as a capacitor, so that it is possible to perform conduction at a high frequency, and it is also possible to implement an antenna function of the branched power feeding transmission line antenna 120I.

Note that, for example, the insulation material 250 may be filled in the region between the metal plate 120I1 and the metal plate 120I2 as illustrated in FIG. 18.

In this case, it is possible to more stably keep the shape (structure) of the branched power feeding transmission line antenna 120I.

### 2. Supplement

Heretofore, preferred embodiments of the present invention have been described in detail with reference to the appended drawings, but the present invention is not limited thereto. It is obvious that a person skilled in the art can arrive at various alterations and modifications within the scope of the technical ideas defined in the claims, and it should be naturally understood that such alterations and modifications are also encompassed by the technical scope of the present invention.

What is claimed is:

1. A metal plate antenna arranged on a substrate, the metal plate antenna comprising:
a parallel part arranged in substantially parallel to the substrate;
a power feeding point contact part extended from the parallel part substantially perpendicularly to the parallel part, and provided in contact with a power feeding point arranged on the substrate; and
a GND contact part formed separately from the power feeding point contact part, extended from the parallel part substantially perpendicularly to the parallel part, and provided in contact with a GND arranged on the substrate,
wherein a contact area of the power feeding point contact part and the power feeding point is narrower than a contact area of the GND contact part and the GND.

2. The metal plate antenna according to claim 1, wherein an antenna length defined by lengths of the parallel part and the GND contact part is determined based on a wavelength of a wireless signal that conforms to specific communication standards.

3. The metal plate antenna according to claim 1, wherein the metal plate antenna is an inverted F antenna.

4. The metal plate antenna according to claim 1, wherein the metal plate antenna is a branched power feeding transmission line antenna.

5. The metal plate antenna according to claim 1, wherein the metal plate antenna is formed by one metal plate.

6. The metal plate antenna according to claim 1, wherein at least one of the parallel part, the power feeding point contact part, and the GND contact part includes a slit or an opening part.

7. The metal plate antenna according to claim 1, wherein at least one of the parallel part, the power feeding point contact part, and the GND contact part includes a stab.

8. The metal plate antenna according to claim 1, wherein a width of a lower end of the power feeding point contact part is formed shorter than a width of an upper end.

9. The metal plate antenna according to claim 1, wherein an insulation material is filled in at least one of between the parallel part, the power feeding point contact part, and the GND contact part.

10. The metal plate antenna according to claim 1, wherein the metal plate antenna is formed by a plurality of metal plates that are not in contact with each other.

11. The metal plate antenna according to claim 2, wherein the specific communication standards include ultra-wide band wireless communication.

12. An antenna device comprising:
a substrate; and
a metal plate antenna arranged on a substrate, wherein
the metal plate antenna includes:
a parallel part arranged in substantially parallel to the substrate;
a power feeding point contact part extended from the parallel part substantially perpendicularly to the parallel part, and provided in contact with a power feeding point arranged on the substrate; and
a GND contact part formed separately from the power feeding point contact part, extended from the parallel part substantially perpendicularly to the parallel part, and provided in contact with a GND arranged on the substrate, and
a contact area of the power feeding point contact part and the power feeding point is narrower than a contact area of the GND contact part and the GND.
